(19) United States
(12) Patent Application Publication
(10) Pub. No.: US 2013/0322689 A1
(43) Pub. Date: Dec. 5, 2013

(54) Intelligent Logo and Item Detection in Video

(71) Applicant: Chris Carmichael, Laguna Niguel, CA (US)

(72) Inventor: Chris Carmichael, Laguna Niguel, CA (US)

(73) Assignee: UBIQUITY BROADCASTING CORPORATION, Irvine, CA (US)

(21) Appl. No.: 13/890,075

(22) Filed: May 8, 2013

Related U.S. Application Data
(60) Provisional application No. 61/647,996, filed on May 16, 2012.
(60) Provisional application No. 61/715,623, filed on Oct. 18, 2012.

(51) Int. Cl. G06K 9/00

(52) U.S. Cl. CPC G06K 9/00711
USPC 382/103

(57) ABSTRACT

Techniques to follow objects in a video. An object detector detects the object, and an object tracker follows that object even when the detectable part cannot be seen. The object can be tagged in its display. The object can be individual team members in a video showing sports. A color filter that is based on colors of a uniform of a team of the team member can be used to restrict an area of said automated object detection.

This application claims priority from provisional application No. 61/647,996, filed May 16, 2012, and from No. 61715623 filed Oct. 18, 2012, the entire contents of both of which are herewith incorporated by reference.

### BACKGROUND

Features and images can be detected using electronic filters to find those features. The filters often correlate across the image, using an electronic criteria to match to the image to find the criteria or to automatically characterize the image.

Objects can be detected in images using feature description algorithms such as the scale invariant feature transform or SIFT. Sift is described for example in U.S. Pat. No. 6, 711,293. In general, SIFT finds interesting parts in an electronic image and defines them according to SIFT feature descriptors also called key points. The key points are stored in a database. Those same parts can be recognized in new images by comparing the features from the new image to the database.

Television is usually sent to a viewer, and can be perceived by a viewer. There are often objects in a television frame.

### SUMMARY

The present application describes using techniques for finding items in a video signal, e.g. a broadcast, using automated image recognition techniques to find the item in the video, and to track the item across multiple frames and mark the tracked item in the multiple frames.

According to one aspect, the tracked item is an item in a sports game e.g. a person identified by a number on an item of their clothing.

In one embodiment, the player or item is highlighted or otherwise marked in a library in a way that allows a user to later view the video based on the information in the library.

### BRIEF DESCRIPTION OF THE DRAWINGS

FIG. 1 shows a functional operation for a dynamic profile;

FIG. 2 shows the functional operation for static profile;

FIG. 3 shows an example of a highlighted player in a sports video;

FIG. 4B shows a simulated overhead feed showing locations of the different players;

FIG. 5 shows a flowchart of operation that is carried out by the overall system; and

FIG. 6 shows a hardware device which carries out these functions.

### DETAILED DESCRIPTION

An embodiment describes feature detection in an image which is a frame of the video, and where the feature detection uses orientation fields to find the feature in the multiple frames. However, other kinds of feature detection can be used according to other embodiments. Orientation fields are described in detail in patent application No. 13/775462, the entire contents of which are herewith incorporated by reference. To summarize, an orientation field can be generated field at all pixels in the image. Then, the techniques operate to measure an alignment and auto-correlation of the orientation field with respect to a data base of models.

The orientation field may describe the orientations that are estimated at discrete positions of the image being analyzed. Each element in the image, for example, can be characterized according to its orientation and location. An embodiment describes using orientation fields as described herein as a way of detecting a broad variety of objects, including textureless objects. A scale invariant orientation field is generated representing each logo. After this orientation field has been generated, a matching orientation field is searched for in the target image.

Letting I(x) denote the intensity at location x of the image I. We define an orientation F(x) at the image location x as the pair F(x)={w(x); θ(x)}, where w is a scalar that denotes a weight for the angle θ. The angle θ is an angle between 0 and 180 degrees (the interval [0, π), and the weight w is a real number such that the size of w measures the importance or reliability of the orientation.

An embodiment describes operations that can detect various features in the video being played. The features can be logos and characters in one embodiment that are found on clothing of a player in the video. One application of this system is to use in following a certain object. For example, this can be used in a television shown as 600 in FIG. 6. As described herein, television includes a processor which carries out various functions. The television can also receive a voice recognition circuit shown as 620 which can be used to command the processor. The television can also have voice synthesis which enables the television to include a voice greeter that indicates to the information to the user. For example, if a viewer is watching a sports game, the voice greeter may indicate the name of the sports game.

The user can also ask the voice recognition system to do things on the television, for example tune to sports game x.

In addition, use of the logo and item detection allows tracking different objects in the video. For example, during watching the sports game, the user might want to track player number 51. A command can then be given to “track player number 51”, e.g., a command by voice.

Player number 51 is then found by the detector that is described herein, and tracked across the different frames or images which make up the video. While following the tracked item, the video can display additional information about the tracked item.

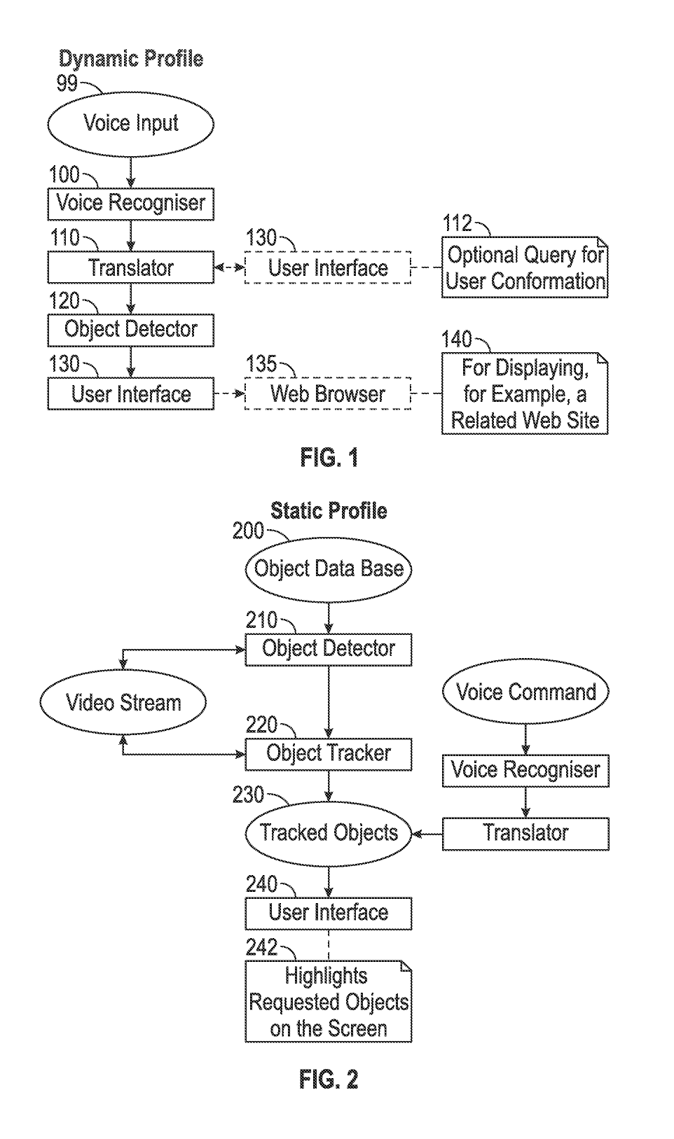

Embodiments describe a system for interactive object detection in video broadcasts. The system can be used in a dynamic mode as shown in FIG. 1, where the system allows detection of arbitrary objects. The system can also be used in a static mode where it continuously detects and tracks a number of pre-determined objects (such as all players in a sports game such as a football game), and highlights the tracked objects upon request from the user.

The object detection engine according to an embodiment relies on the MOFF object detector described in detail in patent application No. 13775462 and summarized above.

The handling according to the dynamic mode, using a dynamic profile that allows detection of arbitrary objects, is carried out as shown in FIG. 1. FIG. 1 represents a flowchart of operations that can be carried out by the processor 610 when using the dynamic profile.

Commands according to embodiments are handled by a Voice Recognizer 620 with the operation shown as 100 in FIG. 1, receiving a voice input. The Voice Recognizer can use either or both of a hardware and/or software component that obtains a voice command and translates the voice command to a text stream. This can use any commercially available speech to text engine running on a general purpose processor, or can use a special purpose processor.

The translator 110 analyzes a text stream created by the voice recognizer 100 and, extracts key words from the text. These keywords can be identified according to a database. The keywords are parsed into appropriate search commands. The output of the search is then translated to one or more objects.

In an embodiment, the database can have a number of different terms that a user might use in order to find items in the picture. For example, words such as ‘find’ or ‘look for’ might be in the database. Words of objects, such as football player, number 57 (or more generally the word ‘number’ followed by any digits), or other such information might also be in the database. Each of these can be identified as a keyword.

The translator can be interfaced with the user interface 130 to provide an optional query for user confirmation shown as 112, for example this may say you are looking for number 57, is that correct?

The object detector 120 operates to detect object(s) from still images or the images or frames of a video stream. The Object Detector returns a list of found objects, along with spatial coordinates of their location, and a time stamp indicated when in the video the object was detected.

As described herein, there can also be an object tracker, which tracks an object given the coordinates of the objects throughout subsequent frames for times when the item being looked for is no longer visible in the frame.

The User Interface 130 collects input from the user, either via screen inputs or voice commands. It returns output to the user, either as information rendered on the screen, or via sound output. As described above, this can be used for optional queries for user confirmation, or to allow the user to enter a specific command. The user interface can be carried out via a web browser, and for example can display a related website shown generally as 140.

The “dynamic profile” shown in FIG. 1 is primarily meant to be used for general purpose object detection. As such, it is typically more computationally intensive since it will be looking for all objects without being given any information about which object specifically it is looking for. This may be less efficient at finding a specific object, but will identify most or all objects. The results of the dynamic tracker may be stored in a library, since the user has not specified any objects to follow when using the dynamic tracker.

The input to the dynamic profile in this embodiment is a user command that can be input as a voice command or by other input methods (mouse controlled menus, icons, hand gestures, etc.). The input command is recognized by the recognizer 100 and then translated by the translator 110. The output of the translator is a set of objects based on interpreting the input command. If the uncertainty of the translator's interpretation of the input exceeds a threshold, the system may then display the suggested objects, and ask for user confirmation shown as 112. In one embodiment, this may also display several objects, and let the user pick the correct one.

Once the translator has decided that an object should be detected (possibly after user confirmation), the object is given as input to the object detector. The object detector uses the object detection engine to detect the object in the current frame. In particular, the object detector may use the MOFF method described in our co-pending application, either alone or in combination with other object detection methods. Another embodiment may use any known object detection method.

The output from the object detector is provided to the user interface, which then determines what to do with the extracted object location. For example, the object may be highlighted, or a browser window may open a display with additional information about the detected object.

According to an embodiment of the dynamic detector, consider the following exemplary scenario. A user is watching an action movie, and wants to know which car the hero is driving. The user gives the voice command “What car is the hero driving?”. The system then automatically detects the car in the scene, and bring up a 3D show room in a browser for the car in question. Alternately, the system can look for the card previous scenes, as marked in the library, for example.

For purposes of this detection, the translator may recognize words representing objects in the scene. In the question “what car is the hero driving” the translator may recognize the words car and driving, therefore looking for a car in the scene. The translator may not recognize some of the other words such as hero, or maybe programmed with a very large vocabulary.

The “static profile” is shown in FIG. 2. This is an alternative embodiment that is used for special purpose object detection, and may be used, for example, for many of the special-purpose tracking functions. For example, if the system is only going to be used for a limited number of tracking items such is only used for tracking during sports games, the static profile may be more efficient. One embodiment is described of tracking certain objects in a football game, where information about the potential objects to be tracked are known ahead of time. In such cases, the system can continuously monitor the video stream for objects of interest, and provide information to the user upon request.

In the FIG. 2 embodiment, showing the static profile, the object database 200 has been told what objects to look for. The object detector 210 continuously monitors the video stream for specified and enumerated objects in the database 200. Such objects might, for example, be all numbers between 1 and 99, which are used to identify players in a sports event. Such might be all things that look like jerseys, that are of the proper color for the teams that are playing.

Once the object detector has detected an item, the object tracker 220 may track this item from frame to frame. As the identifiers of the objects may not always be visible to the camera, even when the object is present in the scene, the system may combine its previous detection result, with results from the object tracker. For example, the system may identify number 21 on a jersey on a player in a game in one frame, tag the player, and track the player's motion in subsequent frames where the player's number may not always be turned towards the camera.

The system can in this way keep a continuous data base of the visible objects in the video stream, where those objects have been defined in advance. The data base becomes the library that stores objects for example. This is shown as 230 in FIG. 2, where the objects are tracked between frames. The tracked objects can be communicated via a user interface 240 which may highlight the objects on the screen shown as 242. One embodiment uses this for a sports game, and looks for all balls and numbers in the scene in order to track the ball and the different players in the scene.

When a user gives a command, the system translator may translate this to the action of highlighting the player with number 21 on the jersey. The system will then query the continuously updated system data base, to extract the location of the player.

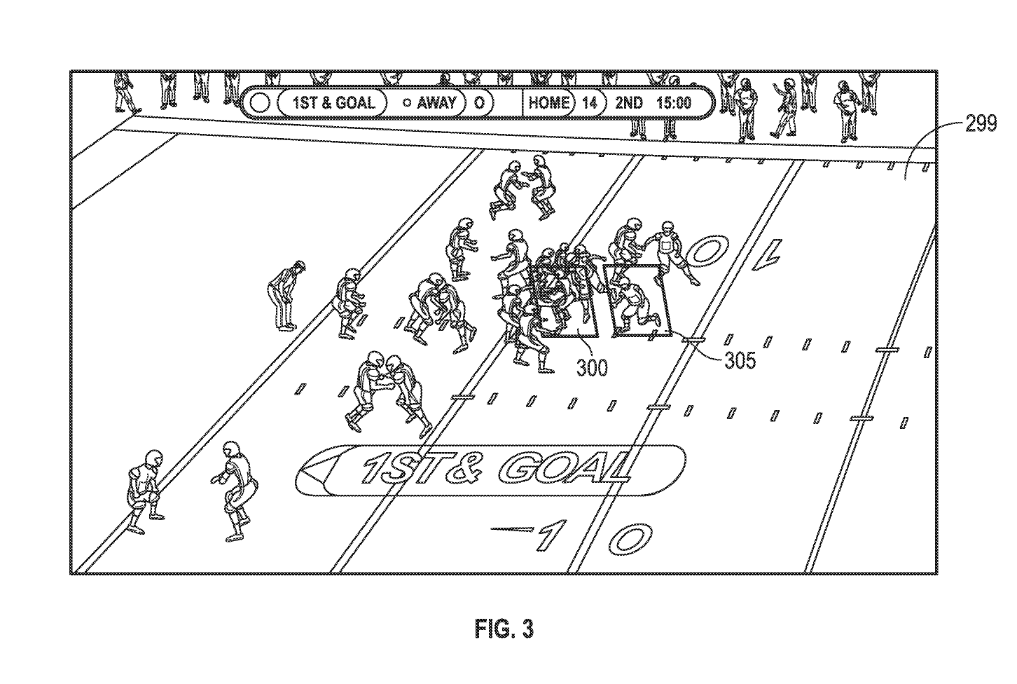

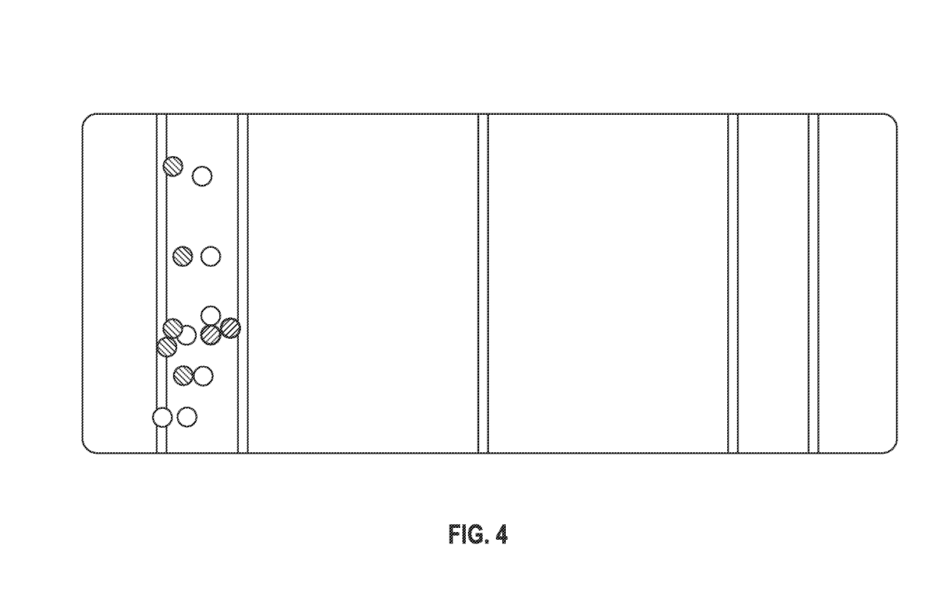

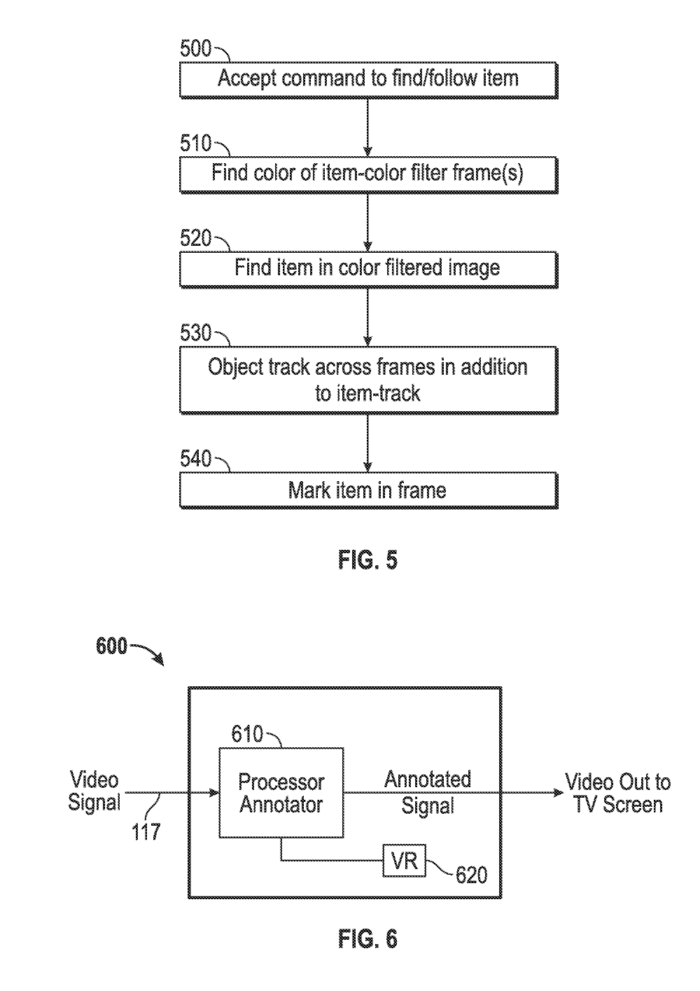

The static profile can be used as follows and as explained with reference to the FIGS. 3, 4A and 4B and the flowchart of FIG. 5. Note that the dynamic profile can be used in the same way, but without specifying in advance the actual items to find.

The user may during a football game on television give the voice command “Highlight the quarterback in red, highlight the running back in blue.” This is shown as 500 in FIG. 5. The system recognizes these terms and finds the players. This can be done, for example, by storing or downloading a list comparing player numbers to player positions, so the quarterback might be number 21, etc.

FIG. 3 then shows in the scene how the system highlights the quarterback in the box 300 which would be shown as blue, and highlights the running back in the box 305 within the football scene 299. These colored boxes move when the players move and are tracked by the system through the scene. This enables easier following of the players during the broadcast.

In order to robustly detect players in a sports broadcast, and in order to reduce the computational burden, a color filter can be applied to each frame as shown in 510. The purpose of this filter is to only highlight areas of the image that contains the color scheme used by a certain team. For example, if a team is wearing jerseys with blue background, the filter applied to the input image will return a result to be further analyzed where only areas of blue color are displayed. The object detection at 520 then only needs to be applied to the blue areas of the image, reducing the amount of computations, and also rules out false positives in areas of other colors.

We assume that each pixel is represented using a multi-channel color format, e.g., RGB format, which is stored in a d-dimensional vector (array). (In typical cases, the dimensionality d=3). We denote the color represented this way at pixel location (i,j) by the vector v_{i,j}. We represent the target color using the same color format, and store that in a d-dimensional vector (array), which we denote v_{target}. We compute the norm of the difference of the two vectors

c(i,j)=∥v_{i,j}-v_{target}∥

Hence, c_{i,j}) is a single number measuring the deviation from the target color at pixel _{(i,j)}.

We introduce a function f(x) with the following properties

f(x) is a monotonically decreasing function.

0≦f(x) ≦1

f(0)=1

Hence, a large value of f(x) indicates a good color match, and a small value of f(x) indicates a bad color match.

We generate the color filtered image by

I_{color-filtered}(i,j)=f(c(i,j))

where (i,j) denotes the pixel location. The object detection is then applied to the color-filtered image I_{color-filtered}.

In order to track an object, such as a player in a sports event, even if the identifying number is not visible, we combine the object detection at 520 with object tracking at 530. This is done by using object detection at 520 whenever the identifying number is visible to the camera(s). Once an object has been identified, the system then uses object tracking to track the player in subsequent frames. The tracking system does not rely on the identifying number, but rather tracks the (moving) object as a whole.

Take as an example following scenario. In frame number 10, a player's number is clearly visible on a jersey. The object detection system identifies this number, and tags the player.

In frame numbers 11-60, the player turns away and is partially occluded by other players, and the player's number is not visible to the cameras. For these frames, we use tracking of the player tagged in frame number 10. The tracking uses whatever part of the player is visible. Hence, even if the chest with the number is occluded, the tracking system may still be able to track the player's head from frame to frame.

Any and all of these techniques can be used to mark the item in the frame at 540.

As an application of the combined detection/tracking system, we can construct the following “aerial perspective” mode of a football game or other game as shown in FIG. 4.

The system continuously detects and tracks all players on the field that are visible in the camera feed(s). By also detecting and tracking reference markers on the field (such as the yard markers in a football game), we can assign a coordinate for each tracked player with respect to a coordinate system covering the full field. By using the coordinates of all tagged players, we can simultaneously with the regular video feed, provide an aerial perspective as illustrated in FIG. 4.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example while the above describes only certain kinds of detections using this technique, it should be understood that there are many more kinds of applications. This can be used to find, for example, logos and advertisements or in videos of various sorts. In sports, this can be used to find logos on team jerseys or numbers on the team jerseys. This can be used for other applications other than sports games, to follow individual items or people in a crowd. Also, the above has described using the objects, as found, contract the object through video. However, in another embodiment, the objects is founder recorded in a library, and then the results are provided to a user based on the results in the library.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system comprising:
an image processor system, receiving a video feed, and detecting at least one item in the video feed in a frame of the video feed, by detecting a recognizable part in said at least one item, and following said at least one item across multiple different frames of the video feed.

2. The system as in claim 1, wherein said image processor system marks said at least one item with an annotation of a specified type that facilitates a user viewing a location of the recognizable part.

3. The system as in claim 2, wherein said recognizable part is a colored box.

4. The system as in claim 2, wherein said image processor marks both first and second items in said video feed, where a first item is marked in a first color and the second item is marked in a second color.

5. The system as in claim 1, wherein said image processor system includes an object detector that detects said at least one item in the frame, and includes an object movement detector that detects movement of said at least one item, across multiple different frames to continue to track said at least one item when said recognizable part is no longer viewable in a frame.

6. The system as in claim 5, further comprising a color filter, that determines a color of said recognizable part, and carries out an initial image reduction so that said object detector reviews only parts of the image that have said color.

7. The system as in claim 1, further comprising a user interface which enables a user to specify the recognizable part to be monitored.

8. The system as in claim 1, wherein said recognizable part is a part of a uniform on a sports team.

9. The system as in claim 8, wherein said recognizable part is a number on a uniform.

10. The system as in claim 6, wherein said recognizable part is a part of a uniform of sports team, and said color is a color of the uniform.

11. The system as in claim 1, wherein the image processor stores a marking in a library.

12. A method to provide interactive control of video content of a broadcast, the method comprising:
using an object detector for robust object detection in a video;
based on detecting the object, using object tracking combined with an object detection output from previous frames, to track objects even when they cannot be detected in current frames;
continuously detect and track objects throughout the broadcast and recording these in a library as tracked objects; and
determining a user's request for a specified object, and highlighting an object by using information about a tagged object in the library.

13. A method for identifying individual team members in a video showing sports, using text of voice commands, the method comprising:
pairing a team member's name with a number for the team member, based on a stored team roster;
identifying the team member via its number on an item of clothing worn by the team member, by using automated object detection on the video and producing output based on said identifying;
using an object tracker to track the team member when the team member 's number is not detectable in the video;
using a color filter based on colors of a uniform of a team of the team member to restrict an area of said automated object detection.

14. The method as in claim 13, wherein the object of clothing is one of a team jersey, helmet, or a hat.

15. The method as in claim 13, wherein the output that is produced is highlighting of an area of the team member in the video.

16. The method as in claim 13, wherein the output that is produced is an entry in a library that can be later read based on information requested by a user.
